(19) United States
(12) Patent Application Publication
(10) Pub. No.: US 2016/0179214 A1
(43) Pub. Date: Jun. 23, 2016

(54) Smartphone Diagnostics - Backspace Analysis

(71) Applicant: Ziv Yekutieli, Zichron Yaakov (IL)

(72) Inventor: Ziv Yekutieli, Zichron Yaakov (IL)

(21) Appl. No.: 14/816,088

(22) Filed: Aug. 3, 2015

Related U.S. Application Data
(63) Continuation-in-part of application No. 14/578,364, filed on Dec. 20, 2014, now abandoned.

(51) Int. Cl. G06F 3/023

(52) U.S. Cl. CPC G06F 3/0233

(57) ABSTRACT

The invention comprises a system and method for analyzing the use of ‘delete’ and/or ‘backspace’ keys generally reserved for erasing entered text. Single backspace strokes record errors on the level of single letters, while multiple backspace strokes are used to erase an entire word or phrase; these two types of mistakes are qualitatively different and are used to analyze the mental state of the typist, by use of software keyboards, keyloggers, or the like running on a smartphone or other computing platform.

### CLAIM OF BENEFIT

This application claims benefit of U.S. patent application Ser. No. 14/578,364 filed 20 Dec. 2014 being a continuation in part thereof, which further claims priority from U.S. provisional application 61/928,033 filed 16 Jan. 2014.

### FIELD OF THE INVENTION

The present invention relates to analysis of keyboard text entry, especially insofar as it relates to correction of mistakes.

### BACKGROUND OF THE INVENTION

A growing segment of the population uses keyboard text entry for a number of purposes, including texting SMS and other types of messages, word processing, filling in online forms, and others. Currently the exact keystrokes used are generally not analyzed; the final resultant text may be stored and studied (for instance to determine popular phrases, common spellings, topics of current interest, and the like but the keystrokes used to arrive at this text is not.

It thus fulfills a long-felt need to analyze keystrokes themselves and not only the text resulting therefrom.

### SUMMARY OF THE INVENTION

The invention comprises a system and method for analyzing keystrokes, and especially the use of ‘delete’ and/or ‘backspace’ keys generally reserved for erasing entered text.

One embodiment involves analysis of the use of single backspace strokes, to record errors on the level of single letters, which will generally be caused by ‘clumsy fingers’, or intentional but incorrect keystrokes such as those involved in spelling mistakes.

Another embodiment involves analysis of the use of multiple backspace strokes such as those employed to erase several letters, entire word, or phrase. These will result from changes in phraseology or mistakes and/or revisions in grammar, and are thus qualitatively different from the ‘single-backspace’ mistakes referred to previously.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 shows several lines of text exemplifying the correction of a spelling mistake.

FIG. 2 shows several lines of text exemplifying the correction of a word.

In the figures and/or description herein, the following reference numerals have been utilized throughout the figures:

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

It has been found that the keystrokes used to produce a body of text themselves contain information beyond that of the text itself. In particular, the number of mistakes made while typing, at both the letter, word, and sentence level, all can be recorded and indicate different types of error made at different cognitive levels.

The first level of the invention involves analysis of the use of single backspace strokes, to record errors on the level of single letters. These backstrokes are used to correct single-letter mistakes caused by ‘clumsy fingers’. Alternatively, the typist may have intentionally typed objectively incorrect keystrokes such as those involved in spelling mistakes, where the typist thinks the word is spelled otherwise than it actually it is.

Another embodiment involves analysis of the use of multiple backspace strokes such as those employed to erase an entire word or phrase. These will result from changes in phraseology or mistakes and/or revisions in grammar, and are thus qualitatively different from the ‘single-backspace’ mistakes referred to previously.

It is within provision of the invention to log keystrokes input on a keyboard, for purposes of analyzing the backspace strokes. The inventive method may be implemented on a smartphone, for instance by means of an alternative software keyboard of the invention adapted to record instances of backspaces, and associated information such as their timing. Alternatively, the inventive method may run on a personal computer, tablet, laptop, or any other computing device having keyboard input, be it through a physical or virtual keyboard of any type.

Software associated with the inventive method is used to either control or replace the keyboard, and/or is in communication with a standard keyboard, and receives keystroke information including instances of back spaces being pressed.

Statistics concerning the use of back spaces may be recorded locally, and/or sent to a server that is part of the inventive method.

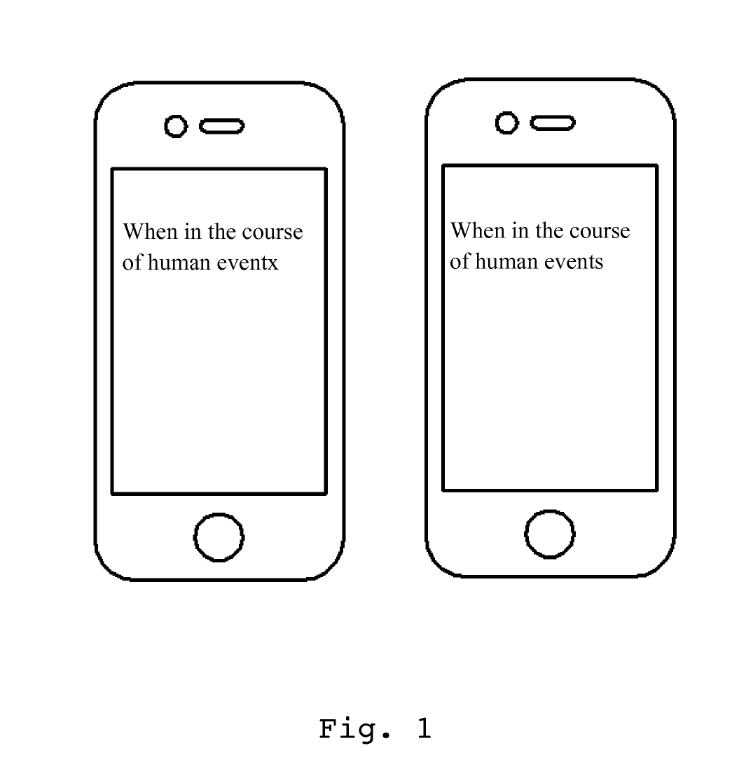

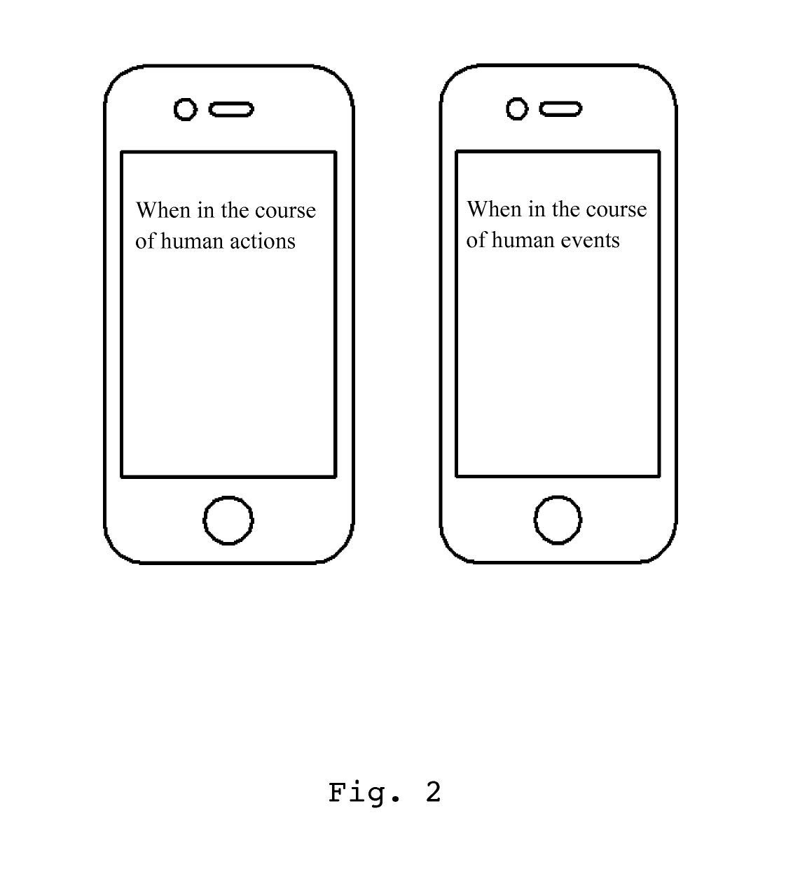

The use of ‘backspace analysis’ is illustrated in FIGS. 1 and 2. In FIG. 1, a series of sentence fragments is shown at three subsequent stages during typing. A single-letter mistake is made in the top line, removed using a backspace in the second line, and corrected in the third line. The frequency with which such corrections may be recorded, along with other metrics such as typing rate, richness of vocabulary, number of mistakes per minute, and the like.

A whole-word correction is shown in FIG. 2, where subsequent lines show stages during correction of an entire word that is written on the first line, erased on the second line, and replaced on the third line. As will be appreciated by one skilled in the art, this is an entirely different class of mistake that the single-character mistake of FIG. 1. As there, auxiliary information may be stored in addition to the rate of whole word mistakes, the words themselves, and associated information.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A system for analyzing the use of delete and backspace keys generally reserved for erasing text, comprising software keyboards or keyloggers adapted for recording single delete and backspace keystrokes to track errors at the level of single letters, and recording multiple backspace strokes to track errors at the level of entire words and phrases, said software keyboards or keyloggers running on a smartphone or other computing platform.

2. A method for analyzing the use of delete and backspace keys generally reserved for erasing text, comprising steps of: recording single delete and backspace keystrokes to track errors at the level of single letters, and recording multiple backspace strokes to track errors at the level of entire words and phrases, by use of software keyboards, keyloggers, running on a smartphone or other computing platform.
